(19) United States
(12) Patent Application Publication
(10) Pub. No.: US 2022/0185706 A1
(43) Pub. Date: Jun. 16, 2022

(54) MONITORING OF MEMBRANE FOULING

(71) Applicant: KEMIRA OYJ, Helsinki (FI)

(72) Inventors: Mehrdad HESAMPOUR, Espoo (FI); Anne MÄKI, Espoo (FI)

(73) Assignee: KEMIRA OYJ, Helsinki (FI)

(21) Appl. No.: 17/600,888

(22) PCT Filed: Apr. 1, 2020
(86) PCT No.: PCT/FI2020/050211

§ 371 Date: Oct. 1, 2021

(30) Foreign Application Priority Data
Apr. 1, 2019 (FI) 20195256

(51) Int. Cl. C02F 1/44; G06T 7/00; G01N 21/64

(52) U.S. Cl. CPC C02F 1/441; C02F 1/442; C02F 1/444; G06T 7/0004; G01N 21/6428; C02F 2103/28; C02F 2209/10; C02F 2303/20; C02F 2303/22; G01N 2021/6439; C02F 2303/14

(57) ABSTRACT

A method is disclosed for monitoring deposit formation in an aqueous process. The method includes providing a feed flow of aqueous liquid onto a receiving surface of a monitoring cell. At least part of the receiving surface is illuminated with a light source. Visual data is collected at a multitude of positions across the receiving surface, and the collected visual data is analysed. A quantitative scaling and/or fouling indication is computed for the receiving surface. The monitoring cell has an inlet for the aqueous feed flow and an outlet for a reject flow from the monitoring cell. The receiving surface includes a selective barrier membrane. The feed flow is directed to the receiving surface at an elevated pressure to produce a permeate part that passes through the selective barrier membrane, and a concentrate part that forms the reject flow.

### FIELD OF THE INVENTION

The present invention relates to a method and an apparatus for monitoring membrane fouling in an aqueous process.

### BACKGROUND ART

Increasing global need for water and wastewater treatment is driving the development of large-scale membrane filtration processes. In particular, water desalination via reverse osmosis (RO) technology provides a solution to the world's water shortage problem providing millions of cubic meter of fresh water from saline water per day. Higher quality, as well as lower energy consumption, has together with environmental demands made membrane processes, such as microfiltration (MF), ultrafiltration (UF), nanofiltration (NF) and reverse osmosis (RO) attractive processes to complement or replace conventional systems and sedimentation processes to remove particles, organic matter and dissolved salt.

Membrane filters are being used in both wastewater treatment to e.g. replace settling of activated sludge processes, and in low/high-salinity water where reverse osmosis with MF and UF pre-treatment as a replacement for conventional granulated or sand filters applied for removing salt from water.

However, the success of membrane and reverse osmosis technology is challenged by the fouling problem. Fouling decreases the permeate flow through the membrane, and is recognized as the main problem in the application of membrane filtration technologies. Several types of membrane fouling exist, including inorganic fouling or scaling, colloidal fouling, organic fouling, and biofouling.

In biofouling, microorganisms form a sticky layer on the membrane surface. Biofouling refers to the deposition, growth and metabolism of bacteria cells or flocs on the membranes. Biofouling leads to higher energy input requirement as an effect of increased biofilm resistance and osmotic pressure, lower quality of product water due to increased so-lutes accumulation on the membrane surface, and thus to significant increase in both operating and maintenance costs.

Paper mills have problems with deposit formation on the surfaces as well. Fouling may occur on the surfaces of water feed pipes, water tanks, splash areas of paper machine wet end or on any metal surfaces in the wet part of a paper ma-chine. Deposits in a paper mill are often organic and may consist of pitch, white pitch, or stickies, or the deposits may be inorganic or consist of biofouling.

Such depositions, when allowed to grow, release undesired particles of organic, inorganic and biofouling deposits to the papermaking process and may lead to end product defects or breakages in the paper web.

In mining industry where water is also much used as a flow and transport medium, depositions may occur on metal surfaces and cause problems e.g. in sieves, filters and membranes used in the process.

Various measures are known in the art to clean and monitor affected surfaces and membranes. Chemicals may be added to the feed water, in order to reduce or eliminate scaling and fouling, and one aspect of e.g. large-scale filtration is to monitor the build-up of scaling and fouling on the equipment. Correct timing and optimization of service and cleaning activities is a significant cost factor, and a monitoring system is also a basis for research around the phenomenon leading to the deposition and agglomeration of various matter, and for control purposes, e.g. for timing and addition of chemicals to the water feed.

### SUMMARY

The following presents a simplified summary of features disclosed herein to provide a basic understanding of some exemplary aspects of the invention. This summary is not an extensive overview of the invention. It is not intended to identify key/critical elements of the invention or to delineate the scope of the invention. Its sole purpose is to present some concepts disclosed herein in a simplified form as a prelude to a more detailed description.

According to an aspect, there is provided the subject matter of the independent claims. Embodiments are defined in the dependent claims.

One or more examples of implementations are set forth in more detail in the accompanying drawings and the description below. Other features will be apparent from the description and drawings, and from the claims.

### BRIEF DESCRIPTION OF THE DRAWINGS

In the following the invention will be described in greater detail by means of preferred embodiments with reference to the attached drawings in which

FIG. 1 shows an example membrane fouling with different flow velocities;

FIG. 2 illustrates an exemplary apparatus;

FIG. 3 shows overall fouling value from MFS, and differential pressure from a membrane process.

### DETAILED DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising”, “containing” and “including” should be understood as not limiting the described embodiments to consist of only those features that have been mentioned and such embodiments may contain also features/structures that have not been specifically mentioned.

The present invention relates to a method and an apparatus for detecting, monitoring and controlling deposit formation on wetted surfaces. More specifically, the invention is directed to the detection and classification of scaling and fouling in water-intensive processes, based on collected visual data from surfaces in process plants or from dedicated monitoring cells.

A method and apparatus for monitoring deposit formation in a process comprising an aqueous flow is provided. According to the invention a feed flow of an aqueous liquid is provided under an elevated pressure onto a receiving surface to be monitored. At least part of a receiving surface is illuminated with at least one light source. Visual data is collected across the receiving surface and analyzed. The quality and type of deposition attached to the receiving surface is classified based on information obtained from the analyzed visual data, and a quantitative scaling and/or fouling indication is computed based on the classification.

### Definitions

Reverse osmosis (RO) Process

Reverse osmosis is a modification of the natural process known as osmosis, wherein of two solutions with different dissolved salt concentrations, water flows from the less concentrated solution to the more concentrated solution through a semipermeable membrane. In reverse osmosis, the flow direction is reversed from concentrated solution to less concentrated solution, by a pressure higher than osmotic pressure. A reverse osmosis membrane passes water and small non-ionized (or non-charged) molecules easily through due to the small molecular size and higher water diffusion but will stop many other contaminants.

Membrane

Membrane is a selective barrier which may operate under different driving forces. A semipermeable membrane may be used e.g. in reverse osmosis systems and may consist of a thin film of polymeric material, usually polyamide, cast on a fabric support. The membrane must have high water permeability and ion rejection. The rate of water transport must be much higher than the rate of transport of dissolved ions. The membrane must be stable over a wide range of pH and temperature and have good mechanical integrity.

Spacer

A mesh-like (net-like) layer situated on top of, essentially parallel to at a constant distance from a surface. The spacer may be made of connected strands of metal, fiber, or other flexible/ductile materials.

Deposit Formation

Deposit formation may consist of scaling, by which in literature is usually meant inorganic fouling by inorganic matter. The deposit may also consist of organic fouling, which is similar but the deposit consists of mainly organic material. Bio-fouling, microbiological fouling or biological fouling, is a deposit caused by the accumulation of microorganisms, plants, algae, or animals on wetted surfaces. A fouling that involves more than one foulant or more than one fouling mechanisms working simultaneously may be referred to as composite fouling. Multiple foulants or mechanisms may interact with each other resulting in a synergistic fouling which is not a simple arithmetic sum of the individual components.

It is thus an object of the present invention to present an improved method and apparatus for monitoring and controlling scaling and/or fouling in filtration processes.

Membrane is a selective barrier which may operate under different driving forces. One of most common driving forces is pressure. Examples of these membranes include microfiltration, ultrafiltration, nanofiltration and reverse osmosis membranes. The membrane may be packed in a membrane module. A liquid flow passes over a membrane surface. Part of the liquid flow goes through the membrane and the rest of the liquid flow passes by without permeating through the membrane. To achieve a desired flow pattern over the membrane, there is a net layer over the membrane. The net layer is called a spacer.

The pressure difference between a membrane inlet, membrane outlet and permeate has a significant influence on the operation and runnability of the membrane. An increased pressure increases water flow through the membrane; however, it also increases bulk flow of retained compounds, e.g. colloidal compounds, microbes and nutrients, towards the membrane. As a result, the membrane gets blocked quicker, and the initial increase in production capacity is not sustained. Therefore, it is desired to determine an optimum pressure (or flow over membrane) which results in sustainable production capacity.

This pressure depends on fluid properties as well as on the membrane module geometry and membrane characteristics. Spacer also play a major role in runnability of membrane. The spacer also affects the runnability of the membrane. A thin spacer provides a possibility to increase the surface area of the membrane per unit of the membrane module. For example, with a thinner spacer a larger surface area may be fit inside of a 4 inches×40 inches membrane module. However, a thin spacer reduces the distance between membrane layers and increases the pressure drop and accumulation of foulants, which result in lower water production by the membrane.

Use of a thicker spacer may reduce the pressure drop over the membrane or decrease foulants accumulation, but in that case a larger number of membrane modules is required, as surface the area per module is decreased. Also here it is desired to determine an optimum.

It is also desired to determine an optimal flow velocity and/or optimal pressure when the membrane is cleaned. This means that the flow velocity and/or pressure may be decreased after the membrane has been cleaned. When the membrane gets fouled, the flow velocity and/or pressure may be increased so that optimal flow through the membrane is achieved. Increased flow velocity may also prevent or at least slow down membrane fouling.

Typically, most of the optimization of a membrane process is done prior to installation of a new membrane to the water treatment plant. This pre-optimization may not be sufficient, as conditions in the treatment plant may vary depending on time etc. Therefore, there is a need to have a membrane fouling simulator online connected to treatment plant.

The present invention describes a new application for a membrane fouling simulator (MFS). The simulator may be installed on a side stream of a full scale water treatment plant. Depending on the target, the membrane and the spacer in the monitoring cells in the simulator may be identical or different. Fouling/cleaning performance as a function of process variable may still be recognized by image processing technique available in MFS.

MFS may have two cells receiving the same water. In a first cell, the flow velocities (here, a linear flow velocity in a channel above the membrane) of the membranes may be different compared to a second cell. It may be observed that the cell having a higher flow (and consequently a higher shear flow) has a lower fouling value (fouling rate) calculated by a Kemira membrane fouling simulator (MFS) software compared to other cell with a lower flow velocity.

In a method according to the present invention for monitoring deposit formation in a process comprising an aqueous flow a feed flow of an aqueous liquid is provided onto a receiving surface to be monitored.

In the monitoring method, a feed flow of aqueous liquid is provided onto a receiving surface to be monitored. The receiving surface is located in a monitoring cell. The monitoring cell may optionally include at least one layer of a spacer applied on the receiving surface. At least part of said receiving surface is illuminated with a light source. Visual data is collected at a multitude of positions across said receiving surface, and said visual data is analysed. A quantitative scaling and/or fouling indication is computed for said receiving surface based on said analysing. In addition or alternatively, at least part of the spacer may be illuminated with the light source, visual data may be collected at a multitude of positions across said spacer, and said visual data is analysed, wherein a quantitative scaling and/or fouling indication may be computed for said spacer based on said analysing. The monitoring cell has an inlet for the aqueous feed flow and an outlet for a reject flow (or discharge flow) from the monitoring cell, and the receiving surface comprises a selective barrier membrane. In the method, said feed flow is directed to the receiving surface at an elevated pressure to produce from said feed flow a permeate part that is passing through said selective barrier membrane and a concentrate part that forms said reject flow. The selective barrier membrane may be a semipermeable membrane. Alternatively the selective barrier membrane may be e.g. a forward osmosis membrane, membrane contactor, or ion exchange membrane. The selective barrier membrane may be of any suitable material and/or structure that allows to produce from said feed flow a permeate part that is passing through said selective barrier membrane and a concentrate part that forms said reject flow.

In an embodiment, said elevated pressure is an overpressure of 0.1 to 60 bar.

In an embodiment, said elevated pressure is an overpressure of 0.1 to 1 bar, typically 0.1 to 0.5 bar, and the semipermeable membrane is a microfiltration membrane.

In an embodiment, said elevated pressure is an overpressure of 1 to 5 bar, typically 1 to 3 bar, and the semipermeable membrane is an ultrafiltration membrane.

In an embodiment, said elevated pressure is an overpressure of 4 to 15 bar, typically 5 to 10 bar, and the semipermeable membrane is a nanofiltration membrane.

In an embodiment, said elevated pressure is an overpressure of 10 to 60 bar, typically 10 to 40 bar, and the semipermeable membrane is a reverse osmosis membrane.

In an embodiment, said feed flow is directed to the receiving surface at said elevated pressure, such that 1 to 99%, at least 2%, at least 25%, at least 30%, at least 80%, or at least 85%, of said feed flow passes through said semipermeable membrane, and such that 1 to 99%, less than 98%, less than 75%, less than 70%, less than 20%, or less than 15%, of said feed flow forms said reject flow.

In an embodiment, said feed flow is directed to the receiving surface at said elevated pressure, such that 1 to 99%, at least 2%, at least 25%, at least 30%, at least 80%, or at least 85%, of said feed flow forms said reject flow, and such that 1 to 99%, less than 98%, less than 75%, less than 70%, less than 20%, or less than 15%, of said feed flow passes through said membrane.

In an embodiment, the method comprises providing at least two monitoring cells, the method comprising providing a first aqueous feed flow onto a first receiving surface to be monitored, wherein the first receiving surface is located in a first monitoring cell and comprises a first semipermeable membrane, providing a second aqueous feed flow onto a second receiving surface to be monitored, wherein the second receiving surface is located in a second monitoring cell and comprises a second semipermeable membrane, wherein the first and second aqueous feed flows are similar to each other or different from each other in terms of flow velocity, flow content, flow origin, and/or flow pressure, and the first and second semipermeable membranes are similar to each other or different from each other in terms of membrane material, membrane type, spacer type, and/or spacer thickness.

In an embodiment, the quality and type of deposition attached to said receiving surface is classified based on information obtained from said analyzed visual data, and a quantitative scaling and/or fouling indication of said receiving surface is computed based on said classification.

In an embodiment, based on information obtained from said analyzed visual data, an overall scaling and/or fouling indication of said receiving surface is computed.

In an embodiment, at least one fluorescent dye capable of staining at least one type of microbes is added to said feed flow of an aqueous liquid. At least part of said receiving surface is illuminated with at least two light sources, at least one of which uses light with a selected wavelength that excites a biofouling deposition stained by said at least one fluorescent dye. The quality and type of biofouling deposition on said receiving surface is classified based on fluorescence emission from said depositions in said analyzed visual data.

In an embodiment, said light source is emitting ultraviolet light.

In an embodiment, at least part of said receiving surface is illuminated with at least two light sources, at least one of which uses light with a selected wavelength that excites inorganic or organic deposition stained by said at least one fluorescent dye.

In an embodiment, a non-fluorescent dye capable of staining at least one type of microbes, may be used instead or in addition to the fluorescent dye. The non-fluorescent dye adsorbs on organic or inorganic foulants and changes the color of the foulants. This change is detectable by camera under light, for example, white light.

In an embodiment, the quantitative scaling and/or fouling indication of said receiving surface is based on one or more of the following: total fouling of said surface, fouling rate, color map of fouling, and/or share or ratio of each fouling type.

In an embodiment, the classification of the quality and type of said depositions on said receiving surface is done in a computer unit by using one or more of the following; shape factors such as aspect ratio, size factors such as size distribution or mean size, color factors such as mean color, color distribution and brightness, of the depositions imaged.

In an embodiment, said monitoring cell includes at least one layer of a spacer applied on the receiving surface.

In an embodiment, said visual data is collected from said spacer and said receiving surface.

In an embodiment, said semipermeable membrane includes a reverse osmosis, nanofiltration, ultrafiltration or a microfiltration semipermeable membrane.

In an embodiment, connecting at least two monitoring cells to be monitored are connected in parallel or in series with regard to the feed and reject flows. Visual data is collected of the surfaces of said at least two monitoring cells.

In an embodiment, said feed flow is at least one of the following: saline water, brackish water, circulated water, wastewater, treated wastewater, reuse water, or industrial process water.

In an embodiment, said feed flow is a side stream taken from a main process stream, and said quantitative indication of said deposition on said receiving surface, compared to a clean surface used as a reference, is used as an input parameter for automatic control of the addition of one or more chemicals to said main process stream.

In an embodiment, said chemical is selected from the group of antiscalants, biocides, coagulants, flocculants, oxidants, cleaning chemicals, polymers and/or any combination thereof.

Thus, an aqueous flow is conducted to a measuring cell, where automatic imaging the measuring cell takes place simultaneously with appropriate illumination of cell. The imaging data is processed, classification of fouling types is carried out, and key variables for the fouling, such as fouling level and fouling rate for each fouling type, are calculated. The calculated variables may be used to determine appropriate measures to be taken against the depositions, specifically for optimizing chemical treatment programs, including parameters like the type and dosage of anti-deposition chemicals to be added, the combination (recipe) of such chemicals, and the choice of dosing points, if available.

The collected visual data from the multitude of positions may, as a matter of design choice, be combined into an image representative of said receiving surface before the analyzing step, or the images may be analyzed individually and the information they contain may be combined to gain an understanding of the depositions on the whole receiving surface. The classification of the quality and type of depositions may be done in a computer by using shape factors such as aspect ratio, size factors such as size distribution or mean size, color factors such as mean color, color distribution and brightness, of the depositions imaged.

The quantitative scaling and/or fouling indication of a receiving surface may be based on one or more of the following: total fouling of said surface, fouling rate, a color map of fouling, share or ratio of each fouling type out of a total fouling value. The fouling variables may, for example, be based on local fouling values, fouling maps over a receiving surface, or a cumulated total fouling value.

Computing of the quantitative indication of depositions may be based on said classification and used as an input parameter for automatic control of the addition of chemicals to the feed flow. The chemical may be selected from the group of antiscalant(s), biocide(s), coagulant chemical(s), oxidant(s), or polymer(s).

At least one of the light sources may be an ultraviolet light source and/or a light source which includes a selected wavelength that produces fluorescence in the illuminated target. It is then possible to classify the quality and type of biofouling deposition involving microbes by adding to a feed flow of aqueous liquid fluorescent dyes capable of staining the microbes, and then by alternately illuminating the deposits on a surface with two light sources, one of which use white light and the other use light with a selected wavelength that excites the fluorescent dye. Ultraviolet light may also cause inherent fluorescence (auto-fluorescence) in the deposits, without any addition of dyes.

The receiving surface to be monitored may be located in at least one monitoring cell having at least one inlet for said feed flow of an aqueous liquid and at least one outlet for a reject flow from said monitoring cell. The feed flow of an aqueous liquid is introduced onto the receiving surface of the monitoring cell, which may include at least one layer of a spacer applied above said surface. The visual data may then be collected both from the spacer and the receiving surface. Spacers are known in the art and are used for distributing and moderating the liquid over a membrane.

The receiving surface may be a semipermeable membrane. A semipermeable membrane produces a permeate part that is passing through said semipermeable membrane and a concentrate part that forms a reject flow. The semipermeable membrane may be a reverse osmosis, nanofiltration, ultrafiltration or a microfiltration semipermeable membrane.

According to one aspect, at least two monitoring cells are provided, which are monitored by connecting them in parallel or in series with regard to the feed and reject flows and visual data is collected from the surfaces each monitoring cell.

Various embodiments of the invention may be used in any water-intensive process. For example, the process may be a filtration process, and it may be a reverse osmosis, nanofiltration, ultrafiltration or microfiltration process for treating salt water, e.g. sea or brackish water, or a filtration process for circulated water or wastewater, or a filtration process for industrial process water, such as paper mill process water or pulp mill process water. It may be used also in water stream systems, such as in internal water circulation and in raw/wastewater treatments, in pulp and/or paper mills or in oil and mining industry, as well as in other water intensive processes, such as cooling water circulation systems.

According to one aspect of the invention, an apparatus for monitoring deposit formation in a process comprising an aqueous flow is provided.

The apparatus for monitoring deposit formation comprises feeding means for providing a feed flow of aqueous liquid onto a receiving surface to be monitored. The receiving surface is located in a monitoring cell. The monitoring cell may optionally include at least one layer of a spacer applied on the receiving surface. The apparatus comprises a light source configured to illuminate at least part of said receiving surface with the light source, an imaging device configured to collect visual data at a multitude of positions across said receiving surface, a data processing unit configured to analyze said visual data, and computing means configured to compute a quantitative scaling and/or fouling indication for said receiving surface based on said analysing. In addition or alternatively, the light source may be configured to illuminate at least part of the spacer, the imaging device may be configured to collect visual data at a multitude of positions across said spacer, the data processing unit may be configured to analyze said visual data, and the computing means may be configured to compute a quantitative scaling and/or fouling indication for said spacer based on said analysing. The monitoring cell has an inlet for the aqueous feed flow and an outlet for a reject flow from the monitoring cell, and the receiving surface comprises a selective barrier membrane. Said feeding means are configured to direct the feed flow to the receiving surface at an elevated pressure to produce from said feed flow a permeate part that is passing through said selective barrier membrane and a concentrate part that forms said reject flow. The selective barrier membrane may be a semipermeable membrane. Alternatively the selective barrier membrane may be e.g. a forward osmosis, membrane contactor, or ion exchange membrane.

In an embodiment, said elevated pressure is an overpressure of 0.1 to 60 bar.

In an embodiment, said elevated pressure is an overpressure of 0.1 to 1 bar, typically 0.1 to 0.5 bar, and the semipermeable membrane is a microfiltration membrane.

In an embodiment, said elevated pressure is an overpressure of 1 to 5 bar, typically 1 to 3 bar, and the semipermeable membrane is an ultrafiltration membrane.

In an embodiment, said elevated pressure is an overpressure of 4 to 15 bar, typically 5 to 10 bar, and the semipermeable membrane is a nanofiltration membrane.

In an embodiment, said elevated pressure is an overpressure of 10 to 60 bar, typically 10 to 40 bar, and the semipermeable membrane is a reverse osmosis membrane.

In an embodiment, said feeding means are configured to direct said feed flow to the receiving surface at said elevated pressure, such that 1 to 99%, at least 2%, at least 25%, at least 30%, at least 80%, at least 85%, of said feed flow passes through said semipermeable membrane, and such that 1 to 99%, less than 98%, less than 75%, less than 70%, less than 20%, less than 15%, of said feed flow forms said reject flow.

In an embodiment, said feeding means are configured to direct said feed flow to the receiving surface at said elevated pressure, such that 1 to 99%, at least 2%, at least 25%, at least 30%, at least 80%, or at least 85%, of said feed flow forms said reject flow, and such that 1 to 99%, less than 98%, less than 75%, less than 70%, less than 20%, or less than 15%, of said feed flow passes through said membrane.

In an embodiment, the apparatus comprises at least two monitoring cells, wherein a first monitoring cell comprises first feeding means for providing a first aqueous feed flow onto a first receiving surface to be monitored, wherein the first receiving surface is located in the first monitoring cell and comprises a first semipermeable membrane. A second monitoring cell comprises second feeding means for providing a second aqueous feed flow onto a second receiving surface to be monitored, wherein the second receiving surface is located in the second monitoring cell and comprises a second semipermeable membrane. The first and second aqueous feed flows are similar to each other or different from each other in terms of flow velocity, flow content, flow origin, and/or flow pressure. The first and second semipermeable membranes are similar to each other or different from each other in terms of membrane material, membrane type, spacer type and/or spacer thickness.

In an embodiment, the apparatus comprises a classifying algorithm for classifying the quality and type of deposition attached to said receiving surface based on information obtained from said analyzed visual data. The data processing unit is configured to compute a quantitative scaling and/or fouling indication of said receiving surface based on said classification.

In an embodiment, the data processing unit is configured to based on information obtained from said analyzed visual data, compute an overall scaling and/or fouling indication of said receiving surface.

In an embodiment, said monitoring cell includes at least one layer of a spacer applied on the receiving surface.

In an embodiment, the imaging device is configured to collect said visual data from said spacer and said receiving surface.

In an embodiment, the semipermeable membrane includes a reverse osmosis, nanofiltration, ultrafiltration or a microfiltration semipermeable membrane.

In an embodiment, the apparatus comprises at least two monitoring cells to be monitored connected in parallel with regard to the feed and reject flows, wherein said imaging device is configured to collect visual data of the surfaces of said at least two monitoring cells.

In an embodiment, the apparatus comprises means for taking said feed flow as a side stream taken from a main process stream, and control means configured to use said quantitative indication of said deposition on said receiving surface, compared to a clean surface as a reference, as an input parameter for automatic control of the addition of one or more chemicals to said main process stream.

In an embodiment, said chemical is selected from the group of antiscalants, biocides, coagulants, flocculants, oxidants, cleaning chemicals, polymers and/or any combination thereof.

Thus the apparatus may include means for adding at least one fluorescent dye to the feed flow of an aqueous liquid. At least two light sources may be used for illumination, one of which uses light with a selected wavelength that excites the used fluorescent dye. The classifying algorithm need then be configured to classify the quality and type of biofouling deposition on said receiving surface based on fluorescence emission from the depositions in the analyzed visual data. However, as mentioned above, ultraviolet light may also cause inherent fluorescence (auto-fluorescence) in the deposits, without any addition of dyes.

The computing of a quantitative indication of the depositions on the receiving surface may be based on the classification as compared to a corresponding clean surface used as a monitoring reference, and is used as an input parameter for automatic control of a chemical dosing to the feed flow. The chemical dosing may include dosing of at least one chemical that is selected from the group of antiscalant(s), biocide(s), coagulant chemical(s), oxidant(s), flocculant(s), and polymer(s).

The present invention offers a multitude of advantages, including early detection of any fouling or scaling in a membrane process involving a commercial membrane cell. It is based on an image analysis system with 1D/2D scanning, which enables monitoring of the whole monitoring cell surface, and of more than one cell at a time. This increases the amount of representative data, and makes the system less vulnerable for misinterpretation of “selective” scaling and fouling on only part of the membrane or surface. With more image data to process and analyze, it is also easier to filter out errors, slight changes in lighting circumstances, etc. Using both an even membrane surface and a spacer in the monitoring cells provide much more contact surface and local turbulence, which provides for microbe growth and thus also for early detection of biofouling.

It is also possible to monitor with one system several water lines or the same water line before and after biocide or chemical treatment. With the method and apparatus, classification of fouling or scaling is provided, including inorganic, organic and biofouling. Automatic or manual dosing of chemicals can be reliably based on information of the measured fouling value/level, the rate and its type. Accurate dosing is helped by monitoring two lines: before chemical dosing (early detection of fouling), and after (detecting the chemical response). The classification of the quality of scaling and fouling is preferably done in a computer by using shape factors, colors, brightness and/or size. Shape factors may be the coarseness, roundness and/or aspect ratio of a particle. The classification may involve comparison of acquired image data to a predetermined reference library containing model images of scaling and fouling, and/or to a completely clean monitoring cell.

A computed classification may be used as an input parameter for automatic control of the addition of antiscaling and/or antifouling chemicals to the feed flow. Such chemicals include performic acid (PFA) which is a peroxide derivative of formic acid that is capable of destroying microbiological cells, and sodium hypochlorite (Na0Cl), also called hypo.

A fouling value/level [%] refers to the fouling surface area per total surface area. A fouling rate [%/h] may refer to the change in fouling value. Values may be measured locally in the measuring cell or values may be average values describing e.g. mean value of the whole measuring cell.

Calculated values for total fouling in a measuring cell (membrane or any other surfaces) may include:

Total fouling value, total fouling rate, color map of fouling, total fouling map of measuring cell (total is the sum parameter of all fouling types),

Total fouling value and total fouling rate for membrane surface, total fouling value and total fouling rate for spacer (if membrane and spacer are included to measuring cell).

Calculated values for various types of fouling in a measuring cell may include:

Mean color, aspect ratio, size distribution, color distribution, fouling value, fouling rate, mean size, count of fouling objects, ratio of fouling value from the total fouling value, fouling map, share of each fouling types,

Fouling value and fouling rate for membrane surface, fouling value for spacer (if membrane and spacer are included to measuring cell).

In order to provide a broad range of scaling and fouling detection, the method may include computerized classification of the quality of scaling and fouling on the monitoring cell by evaluating shape, colors or grey scale intensity and/or size of any detected scaling and fouling. The quantity of scaling and fouling on a monitoring cell is determined by comparing the obtained visual information to visual information representative of a clean monitoring cell. Advantageously, the computed scaling and/or fouling indication may be used as an input parameter for dosage control of scaling cleaning and/or antifouling chemicals in the main filtration process.

The invention may be used in membrane processes such as reverse osmosis, nanofiltration, microfiltration and ultrafiltration for a variety of applications. For example, the method and apparatus may find use in desalination of sea water or brackish water, in processes for purifying wastewater or circulated water. It may also be used in water stream systems in pulp & paper mills or the mining industry, as well as in other water intensive processes to estimate agglomeration of impurities on a suitable surface of the plant itself or in monitoring cells.

As used herein, the term “fouling indication” or “scaling indication” may take a number of forms. It may refer to a contaminated surface area as a percentage of a total surface area. It may also refer to the change in the fouling compared with an earlier observation, or to the rate of change of fouling, e.g. as a percentage/time unit. Moreover, a total fouling value and rate may be computed as a fouling indication of a combination of surfaces, e.g. a membrane and a spacer, if such are both monitored. Furthermore, a fouling indication may be a combined fouling indication consisting of individually measured fouling indications for different fouling types. Finally, a fouling indication may take one or be a composite of several factors, such as the mean color, aspect ratio, size distribution, and/or color distribution of the depositions, the fouling value, fouling rate, mean size, count of fouling objects on a surface, etc.

Various kinds of fouling deposits may develop on spacers. The spacers are a mesh-like network that is placed on the top of membrane to distribute and control the incoming feed flow. Spacers contribute to the pressure drop across the membrane, which increases because of deposits, such as scaling and fouling accumulation. The spacer or membrane or any surface where deposits may develop may be monitored with the inventive method and apparatus. For monitoring purposes however, the more contact surfaces there are present in the image field of a monitoring apparatus, the faster a deposit build-up may be discovered and diagnosed, and the appropriate counter-measures planned and executed.

The deposits may be filaments attached to the spacer. The filaments may be seen by eye, although the outlines of filaments may be difficult to recognize. However, with an imaging device such as a digital camera and appropriate image processing software, it is possible to automatically construct the outlines of thin and elongated filaments, e.g. by relying on local image gradients and weight the longitudinal direction of each filament. Such filaments may thus be identified and classified.

The deposits may be filaments, black soil particles, inorganic fouling and/or organic fouling, which are recognized by a color camera and may thus be separated and classified.

Deposition classification schemes are based on object size, shape, texture and color. Filaments are elongated, thin webs. Fibrous objects have constant width and large length/width-ratio. Micro-bubbles are spherical and their images have bright midpoints. Sand and rocks are fully black. Crystals are bright and they possess straight elements and sharp edges.

Color-based classification schemes may be used to differentiate colorful species from grey, colorless species. The main color of each object may be reported and the colorful species may be further discriminated in color classes, e.g. green and round objects may be classified as algae. Classification methodology and algorithms are explained in detail later on.

Biofouling is dominantly a feed spacer problem, as biofilm accumulation on the feed channel spacer influences the velocity distribution profile. Therefore, biofouling control need low fouling feed spacers and hydrodynamic conditions that restricts the impact of biomass accumulation on the feed channel pressure drop.

Fluorescent dyes may therefore be added to a feed flow of an aqueous liquid, which are capable of staining desired types of microbes. When illuminating biofouling depositions with two different light sources, of which one at least uses light with a selected wavelength that excites a fluorescent dye, it is possible to enhance the classification and identification of biofouling depositions. This is based on fluorescence emissions from the depositions. Microbe staining chemicals may work with different mechanisms depending on the microbes, e.g. through the metabolism of the microbes, and their status (viable, non-viable or dead). For example, CTC (tetrazolium salt 5-cyano-2,3-ditolyltetrazolium chloride and DAPI (4′,6-diamidino-2-phenylindole) are known compositions with microbe staining capability.

The present invention addresses both the problem of the biofouling deposition, and the organic and inorganic fouling. Biofouling often represents a more challenging problem than other deposits. Visually biofouling is different from other deposits in that it may become filamentous. Also, compared to smooth nonporous surfaces, membrane biofouling is a complicated process and is affected by many factors, including operating conditions, such as shear and pressure, characteristics of the bacteria themselves, the membrane surface, and environmental factors such as pH, ionic strength, and ion species. Finally, microbial communities are adaptive. Thus environmental pressures (such as chemical or physical stress) eventually select for organisms that tolerate those conditions to colonize the surfaces.

Initial bacterial deposition and biofilm development may start on the membrane and develops as a biofilm over time to cover more areas and starts to grow on the spacer. Microorganisms actively colonize over membranes using a broad range of behaviors that may be categorized into a series of defined stages that include: reversible and irreversible attachment (mostly electrokinetic and hydrophobic interaction), movement of reversibly attached cells across the surface and initiation of micro-colony formation, maturation, differentiation and finally biofilm dissolution and dispersal.

Once a membrane surface has become coated in a layer of foulants, subsequent build-up of fouling depends largely on the interaction between the fouled surface and thereto attached foulant. If the suspension is thermodynamically stable, no further absorption occurs, resulting in a relatively small decrease to a stable flux. If, on the other hand, the suspension is unstable, additional layers of fouling will build up, and a sustained decline in flux is observed.

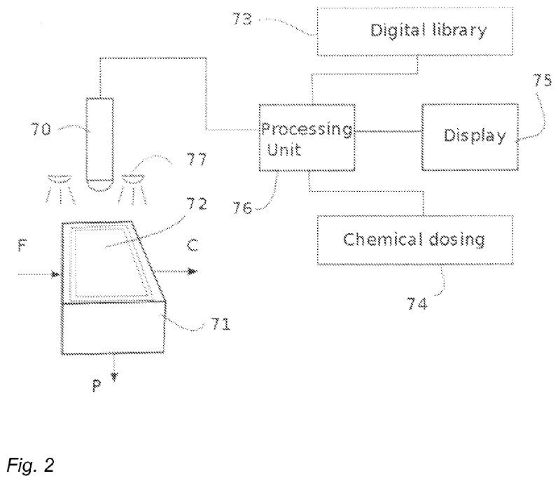

In FIG. 2 is shown a schematic picture of an exemplary apparatus. A camera 70 is collecting visual information from the upper surface 72 of a monitoring cell, such as a reverse osmosis cell 71. The cell 71 is provided with an input feed flow F, an output C for the non-filtered concentrate flow, and another output P for the filtered permeate flow. It is to be noted that scaling and fouling deposits may be monitored and analyzed both on surfaces 72 that is semipermeable. The scaling and fouling takes place on the receiving surface and the spacer.

When having at least one spacer layer applied on the receiving surface, the visual data may then be collected both from the spacer and the receiving surface. This is accomplished either by focusing the lens on the two pictured monitoring cells in turn, or by having a sufficient depth of field in the lens to make both sharp simultaneously.

The camera 70 collects information from the surface 72, necessary illumination being provided by lamps 77. The lighting fixture 77 may, for example, consist of LED lamps or arrays, lasers, xenon lights or halogen lights. The light may be constant or intermittently flashing (strobe light). The used light may also be of any desired wavelength, in order to best bring the form and features visible to the camera. By using white light, it is possible to get information of the color, brightness, shape and size of the fouling. In some embodiments more than one light source may be used, of which at least one may use ultraviolet (UV) light and/or at least one may use light that produce fluorescence emissions in the illuminated target.

The method and apparatus may be based on imaging analysis technology and the use of different light sources for illumination, like white light and UV-light, for example. By using UV-light it may be possible to further enhance the type classification of fouling. As at least some organic fouling absorb UV-light, they appear as dark objects in an image taken with UV light. Biofouling again may contain components that produce fluorescence when they are excited by UV or some other light with a suitable wavelength. Such depositions may be seen as bright objects in the images.

A receiving surface, with or without grids, may be illuminated by means of different light sources for illumination with white light and/or UV-light. By using UV-light, biofouling may be identified and measured. By using white light, especially other fouling types may be identified and measured.

Data processing unit 76 analyzes the collected visual data from the receiving surface 72. The data processing unit 76 also classifies the quality of scaling and fouling on the receiving surface based on information obtained from the visual data and compares it with stored information in a digital library 73. Such a library may comprise a selection of pictures or graphic representations of different scaling and fouling types, to which the visual data is compared and the classification is carried out by using pre-determined classification rules/criteria. The library may of course be targeted to cover the specific process or situation in question.

Finally the data processing unit 76 computes a scaling and/or fouling indication or index which is displayed on display 75 or sent to any other output means for evaluation and, optionally, sends a control signal to a chemical dosing device 74 of a main filtration or other process. The method and system may operate on a separate feed flow taken out by any means from a main process (not shown).

The processes to be monitored by the method and apparatus include desalination processes of sea or brackish water, wastewater and circulated water, for example. The filtration units may be reverse osmosis membranes, nanofiltration membranes, ultrafiltration membranes and/or microfiltration membranes. The usability of the invention is thus not depending on the liquid to be filtered, or the quality or grade of the filter. The method is based on monitoring and comparing, which means some knowledge is assumed on the fouling and scaling that may occur, and how it builds up on the surfaces. Once this knowledge is established, the method and apparatus may be successfully employed.

An exemplary monitoring unit for monitoring scaling and fouling in a process may contain cells to be monitored and an imaging device mounted on a framework. The framework is arranged to move the imaging device with its illumination devices across cells to be monitored to collect visual across their surfaces. The imaging device, preferably a digital CCD camera equipped with a high-magnification lens, may be movable. Alternatively the camera may be in fixed position over the cells, but being able to picture their upper surfaces by scanning. The camera may be mounted on a linear guide powered by a stepper motor which moves the camera between multiple imaging locations.

The camera may be used to measure scaling and fouling from identical separate measuring cells. Images from the camera are analyzed with an analysis software running on an industrial PLC, and the analysis results are transferred to the PLC's data block for data acquisition and visualization on the HMI panel.

The cells are connected in parallel or in series to provide a larger sample of the same process step in a filtration plant. They may also be connected to different flow streams and be used for showing the situation in different steps of the filtration process. This is useful e.g. when studying effects of e.g. added antifouling chemicals or changed process parameters.

A measuring cell may be illuminated with white and UV LED lights, the UV wavelength being 395 nm, for example. A CCD camera and a unit for processing imaging data may also be provided.

In a first step, an aqueous flow, in some embodiments containing at least one fluorescent dye, is conducted to the measuring cell. The measuring cell is alternately illuminated with white light, and an UV- or a fluorescent excitation LED light. Visual data is collected from the measuring cell. The imaging and illumination are synchronized, if needed, to produce images by each scan of the camera. The image data is then pre-processed and the fouling types are identified and classified. Black objectives are classified as organic fouling and fluorescence-emitting objects are classified as biofouling. The key variables for the fouling, such as the fouling level and fouling rate for each type is then computed. The computed variables are then used for monitoring and controlling the fouling in water intensive processes, e.g. membrane processes, water streams in industrial processes, such as in pulp and paper mills. The system may be used to calculate chemical dosages and for optimizing chemical programs, including adjustable parameters like recipes of chemicals, their combinations and dosing points.

An aqueous sample may enter to a sample tank. One or several fluorescent dyes may be added to the sample input flow from an assay or container with a controlled feeding arrangement. The mentioned dye may also be added directly to the inlet flow of the monitoring cell(s). Then the sample is taken through the monitoring cell and out of the apparatus.

A data processing unit that may be used in the apparatus may comprise a programmable logic controller (PLC), for example, a Siemens S7-1200 PLC may be used to control the operations of the analyzing equipment. Alternatively, Beckhoff automation technology may be utilized in the data processing unit. An industrial or general-purpose computer runs the analysis software required for the visual data processing and image rendering. Further main components are a touchscreen interface, such as a Human Machine Interface Panel, for example, a communication software library and the internet.

The communication library may be an Open Data Communications Data Access (OPC DA) client that provides the analysis software running on the computer with synchronous read and write access to the PLC's memory. The analysis software requests a connection from the communication library which then tries to establish the connection to the PLC. The connection is then active until the analysis software is closed, and provides access to various PLC memory variables for the analysis software via a multitude of functions.

The PLC program may be used to control operations of the exemplary systems. It has a data block used for online data-acquisition via a router that sends the data to a server on the internet. The hardware controller controls e.g. control valves, a linear guide driven by a stepper motor, the camera, and a LED ring light for illumination. A control signal to a chemical dosing device may be sent over a network or over a dedicated line to a valve in practice controlling the chemical dosage to a main process.

The PLC 101 also has a data block which may be accessed symbolically and that contains software modules designed for camera and lighting control.

The touchscreen user interface may be used to control the apparatus, to configure the connection settings, set the analysis parameters and to visualize the current status of the analyzer.

In the method, a water feed flow which may contain at least one fluorescent dye, is fed to at least one receiving cell, having, for example, a reverse osmosis (RO) membrane fitted. A camera support (framework) may be employed to move the camera to cover the surface of the at least one RO cell. The camera is taking pictures, i.e. collecting visual data, at or from predetermined spots of the upper surface of the cells. Having covered the whole area to be monitored, the collected visual data is analyzed. Analyzing the data means here processing the data in order to make it comparable with pre-stored visual information about scaling and fouling and comparing the data with pre-stored visual content in a digital library.

Based on the analysis, the type and amount of fouling and scaling may be identified. An indication, index or any predetermined parameter, that is a quantitative and/or qualitative measurement result of the deposits on the RO cell, is computed.

As an example of deposition classification, a Bayesian—Laplace probabilistic classification approach may be used, which is robust and well suited to discriminate different species of deposits from each other. As a rule, all objects should be classified to one specific object or particle class, like filaments, deposits of crystals, scales and other fouling objects. The classification may also rely on a hypercube approach, which means that a particle is classified to a particle class when particle's every property remains between the discrete minimum and maximum limits specified for the class.

In the following, an exemplary sequence of steps to classify an object, i.e. a deposit that has been imaged on a receiving surface is described. A classification scheme may include the phases 1-3 of:

Image filtering is utilized to remove noise, to fade out an unequal background, to highlight the focused objects, and to compute e.g. local greyscale gradient values and their direction. A filtered image may then be equalized e.g. by multiresolution analysis, e.g. using a Gaussian multiresolution pyramid. A Laplacian image (which is the second derivative of image greyscales) may then be computed from an equalized image to highlight the regions of the greatest greyscale variance.

The purpose of an image segmentation step is to recognize focused objects in an image and to compute the projective areas and outlines of the objects, and to recognize different types of objects in such image.

Dark regions are recognized by applying a greyscale percentile threshold to a cumulative greyscale histogram of an equalized image. The background of an image may be computed as the mean image of the previous 10 images. Thus structural components of the area to be monitored, like spacers, may be digitally masked at an early stage from the segmentation analysis of the image.

Deposits, i.e. stagnant objects that are slowly building up, are identified from the image using the above mentioned greyscale percentile threshold. The total area of the deposited objects per total image area ×100% may be used as an indicator of a current fouling value.

Focus discrimination on a Laplacian image may be used to validate objects. Objects which projected area has more focused pixels relative to the total area than a user-specified focus ratio (e.g. 7%), are recognized as valid. Regions of high greyscale variance may be highlighted by combining Laplacian, gradient and highpass filtered images. A binary image of the objects is obtained by applying to the combined image a user-specified contrast threshold and by superimposing on the image the dark regions.

A binary image of an object may be processed with morphological operations. As the projective area of each object is imaged by the camera, the object diameter d is defined based on the object's projective area A.

The morphology of objects may further be studied by defining their shape properties, including the aspect ratio, roundness, and coarseness.

When an object is recognized as an elongated object, an analysis may be carried out to obtain the length and width of the object. An analysis algorithm may be used, where the object length may be computed as the length of the outline (perimeter) divided by two. The width computation may be based on outline vectors consisting of the x, y coordinates and the greyscale gradient direction value of each outline pixel. A matching point at the opposite side of the image outline is searched by comparing the direction values of the opposite outline pixels and of a line drawn between the matching pixels. The distance between the opposite pixels corresponds to the local width of an object, the overall width of which may then be computed as the mean of all local widths.

The principal axes and aspect ratio of deposits may be computed from the object by using principal component analysis (PCA) algorithm. The algorithm returns the major and minor axes of the object and their orientation angle. The aspect ratio may be computed as simply the ratio between the major and minor axes of the object.

Roundness describes how close to a circle an object is. A perfect circle has a roundness of 100%. The roundness percentage decreases with an increasing complexity of the particle shape.

The normalization is obtained by dividing the standard deviation of radii with the object radius.

The coarseness of an object may be computed as the sum of discrete curvatures along the outline of the object divided by the length of the outline. Curvature values may be computed as a difference between the greyscale gradient direction angles of neighboring outline pixels. Only rapid turns in the curvature are counted in the coarseness computation. The coarseness value may be normalized with the perimeter value of a circle having the same diameter as the maximum distance across the object. Kurtosis may be calculated by using 4th momentum of grey scale intensity. This may be used for classification of fouling type.

All detected objects in the receiving surfaces are classified to a one specific fouling type (e.g. biofouling, organic fouling and inorganic fouling or their combination(s)) according to predetermined classification criteria. Classification criteria may also include colors detectable from deposits by using white, ultraviolet or fluorescence excitation light, alone or in combination.

The texture of an object is used for cognitive recognition. Texture analysis may be done by modelling the object texture by studying the brightness (i.e. greyscale intensity) profile from the object center point to its outline. The mean brightness values are computed at the particle center, at the particle outline and at the full particle area. Also the standard deviation of particle's brightness values is computed. The mean brightness values may be utilized to discriminate particles to bright and dark classes and to classify bright and thin objects.

Examples of application areas are to be found in the paper industry and its water streams. Other examples are oil, mining or water treatment processes, in particular, desalination processes, membrane processes, cooling water treatment, and water reuse. Specifically in the paper industry, the subjects for monitoring efforts are organic, inorganic and biofouling, and combinations thereof.

The invention may be used both for monitor and control of the water-intensive processes involved, and thus to control the addition rate of one or more process chemicals. Controlling may be carried out manually, semi-automatically or automatically based on the scaling/fouling analysis carried out according to the invention.

In the method, visual data may be collected at a multitude of positions across a receiving surface, and the visual data is analyzed and classified to determine the quality and type of deposition attached to the receiving surface. In the method it is possible to recognize and classify different fouling types. Fouling type may be inorganic, organic or biofouling. The used deposition classification schemes may be based on object size, shape, texture and color. The method enables measuring the properties of several fouling deposits. It discloses how to identify and classify several different fouling deposits, and enables detecting multiple foulants and classification of foulants attached to the same receiving surface. In the method, actual deposits of all kinds may be monitored, classified and reported. These deposits may include organic, inorganic, and/or biofouling.

It is to be understood that the embodiments of the invention disclosed are not limited to the particular structures, process steps, or materials disclosed herein, but are extended to equivalents thereof as is recognized by those skilled in the art. It is also to be understood that terminology employed herein is used for the purpose of describing particular embodiments only and is not intended to be limiting.

Throughout this specification, a particular feature, structure, or characteristic described is included in an embodiment of the present invention.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art recognizes, however, that the invention may be practiced without one or more of the specific details, or with other methods, components, materials, etc. In other instances, well-known structures, materials, or operations are not shown or described in detail to avoid obscuring aspects of the invention.

An embodiment enables estimating when and/or how often the membrane of the simulator and/or the full scale plant needs to be cleaned. An embodiment also enables obtaining a more accurate and reliable estimate for the pressure drop on the membrane.

The obtained fouling indication may also be used for controlling the addition of chemicals for cleaning the membrane. An embodiment enables monitoring the effect of the cleaning chemicals on the membrane cleaning.

An embodiment enables comparing the fouling effect on membranes of different liquid flows by using (at least) two monitoring cells. For example, the liquid flow through a first membrane may be untreated water (having no treatment chemicals added in it), and the liquid flow through a second membrane may be treated water (having treatment chemicals added in it). The fouling rate or fouling type of the two membranes (two monitoring cells) may then be monitored and compared. Based on the comparison, information is obtained that may be used for automatic control of the addition of one or more chemicals to the main process stream. Further, based on the comparison, information is obtained that may be used for selecting a specific membrane type for a specific flow type of the main process stream.

An embodiment enables monitoring the effect of the flow velocity, flow content, flow origin, flow pressure, membrane material, membrane type, spacer type, and/or spacer thickness on the membrane fouling. An embodiment also enables classifying the membrane fouling based on the obtained image processing data. The classification of the membrane fouling may be based on the quality and/or type of fouling, including shape factors such as aspect ratio, size factors such as size distribution or mean size, color factors such as mean color, color distribution and brightness. The image processing data is obtained by means of the imaging device as described above.

The method and apparatus may be used in a water treatment process, such as a waste water treatment process, and/or a drinking water treatment process, in an industrial process, such as an industrial process of food and beverage industry, pulp and paper manufacturing, and/or oil and gas industry, and/or in a mining process, to predict or estimate fouling and/or deposition of impurities on a selective barrier membrane receiving surface in said process.

In an embodiment, the volume flow rate of the aqueous flow to the monitoring cell is selected or adjusted such that the volume flow rate per membrane surface area in the monitoring cell corresponds, and/or is comparable (e.g. by using a monitoring cell specific correlation factor), to the main process volume flow rate per main process membrane surface area.

In an embodiment, the elevated pressure (overpressure) of the feed flow of the aqueous liquid to the receiving surface of the monitoring cell is selected or adjusted such that the elevated pressure (overpressure) in the monitoring cell corresponds, and/or is comparable (e.g. by using a monitoring cell specific correlation factor), to the overpressure of the aqueous flow to the receiving surface of the main process.

In the membrane process according to an embodiment, a high pressure is applied to the monitoring cell by taking a side stream from the aqueous flow of the main process stream, in order the operating conditions in the monitoring to correspond (to simulate) the operating conditions of the membrane process of the actual/main process. In an embodiment, the high pressure monitoring cell(s) is (are) operating at process conditions, without using a pump, thereby enabling that membrane fouling is influenced by operating conditions of the main membrane process. For example, a higher pressure increases the rate of membrane fouling, while a higher flow velocity reduces membrane fouling. In an embodiment, the receiving surface is run at similar conditions (e.g. pressure, temperature, and/or flow rate) compared to the main industrial process, to generate representative and reliable simulation results about membrane fouling in the main process. This means that the monitoring cell(s) in MFS is (are) run at similar conditions (e.g. pressure, temperature, and/or flow rate) compared to the main industrial process, to generate representative and reliable simulation results about membrane fouling in the main process. In an embodiment, the device (MFS) is connected to a side stream of the main process such that pressurized aqueous liquid flows to the inside of the device (MFS).

Complexity of the device and monitoring system is reduced as no pump is required in the embodiment to maintain the elevated pressure in the monitoring and on the receiving surface. If a pump were used, controlling and avoiding sudden changes in flowrate would be required. This means a sophisticated control system for the pump would need to be in place, which control system should be aligned with other controllers, e.g. inlet valves and backpressure valves. These disadvantages and complexity are avoided in the present invention. An embodiment also eliminates the risk of bubble formation at an outlet of a pump, caused fluctuation in the inlet flow or cavitation. The bubbles would interfere with image processing and may be detected as foulants.

### Example 1

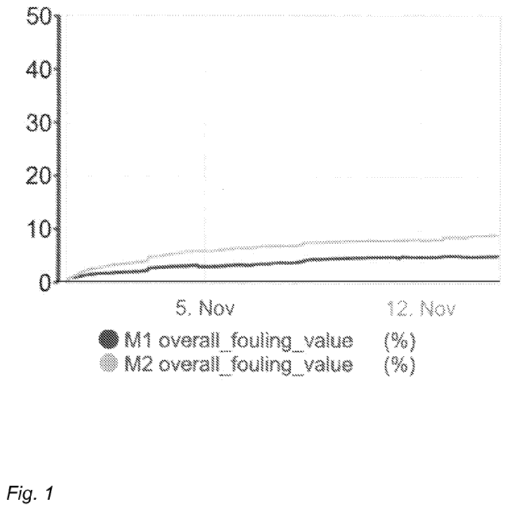

FIG. 1 shows results obtained from a membrane fouling simulator analysis program, showing fouling value (%) as a function of time. In the example shown in FIG. 1, the membrane cells 1 and 2 were identical i.e. they had the same type of membranes and same type of spacers. In the example of FIG. 1, the membrane cells 1 and 2 received the same aqueous flow, except that different flow velocities were used in the membrane cells 1 and 2. In the example of FIG. 1, cell 1 (M1 in FIG. 1) had a lower flow velocity compared to that of cell 1 (M2 in FIG. 1). As can be seen from FIG. 1, the overall fouling rate was different in cell 1 and cell 2. The cell with the lower flow velocity (cell 2) had a higher fouling percentage value compared to cell 1 that had a higher flow velocity and a lower fouling percentage value. This was because the increased shear rate in cell 1 removed foulants from the receiving surface more efficiently. Thus, by applying different flow rates, an optimal flow velocity with the lowest fouling rate may be found.

### Example 2

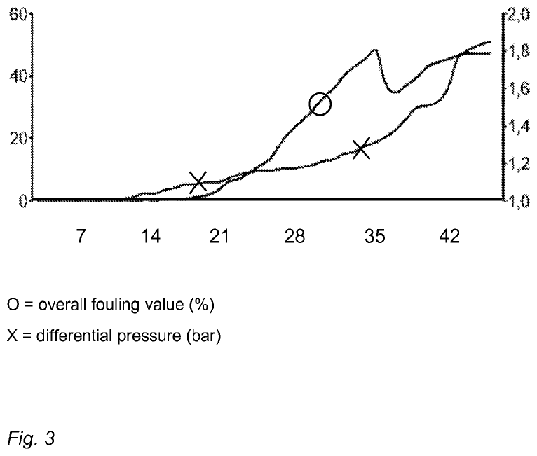

FIG. 3 (left hand side y axis) shows overall fouling value (%) from MFS as a function of time (days (x axis)). FIG. 3 (right hand side y axis) also shows differential pressure (bar) from a membrane process as a function of time (days (x axis)).

It will be obvious to a person skilled in the art that, as the technology advances, the inventive concept can be implemented in various ways. The invention and its embodiments are not limited to the examples described above but may vary within the scope of the claims.

1. A method for monitoring deposit formation in a process comprising an aqueous flow, the method comprising:
providing a feed flow of aqueous liquid onto a receiving surface to be monitored, wherein the receiving surface is located in a monitoring cell;
illuminating at least part of said receiving surface with a light source;
collecting visual data at a multitude of positions across said receiving surface;
analyzing said visual data; and
computing a quantitative scaling and/or fouling indication for said receiving surface based on said analysing;
wherein the monitoring cell has an inlet for the aqueous feed flow and an outlet for a reject flow from the monitoring cell, and the receiving surface includes a selective barrier membrane; and
wherein said feed flow is directed to the receiving surface at an elevated pressure to produce from said feed flow a permeate part that is passing through said selective barrier membrane and a concentrate part that forms said reject flow.

2. A method according to claim 1, for monitoring deposit formation in a process having an aqueous flow, the method comprising:
providing the feed flow of aqueous liquid onto a receiving surface to be monitored, wherein the receiving surface is located in a monitoring cell, wherein said monitoring cell includes at least one layer of a spacer applied on the receiving surface;
illuminating at least part of said receiving surface and/or spacer with a light source;
collecting visual data at a multitude of positions across said receiving surface and/or spacer;
analyzing said visual data; and
computing a quantitative scaling and/or fouling indication for said receiving surface and/or spacer based on said analysing.

3. A method according to claim 1, wherein said elevated pressure is an overpressure of 0.1 to 60 bar, and/or the selective barrier membrane is a semipermeable membrane.

4. A method according to claim 1, wherein said elevated pressure is an overpressure of 0.1 to 1 bar, and/or 0.1 to 0.5 bar, and the membrane is a microfiltration membrane.

5. A method according to claim 1, wherein said elevated pressure is an overpressure of 1 to 5 bar, and/or 1 to 3 bar, and the membrane is an ultrafiltration membrane.

6. A method according to claim 1, wherein said elevated pressure is an overpressure of 4 to 15 bar, and/or 5 to 10 bar, and the membrane is a nanofiltration membrane.

7. A method according to claim 1, wherein said elevated pressure is an overpressure of 10 to 60 bar, and/or 10 to 40 bar, and the membrane is a reverse osmosis membrane.

8. A method according to claim 1, wherein said feed flow is directed to the receiving surface at said elevated pressure, such that:
1 to 99%, and/or at least 2%, and/or at least 25%, and/or at least 30%, and/or at least 80%, and/or at least 85%, of said feed flow passes through said membrane, and
1 to 99%, and/or less than 98%, and/or less than 75%, and/or less than 70%, and/or less than 20%, and/or less than 15%, of said feed flow forms said reject flow.

9. A method according to claim 1, wherein said feed flow is directed to the receiving surface at said elevated pressure, such that:
1 to 99%, and/or at least 2%, and/or at least 25%, and/or at least 30%, and/or at least 80%, and/or at least 85%, of said feed flow forms said reject flow; and
1 to 99%, and/or less than 98%, and/or less than 75%, and/or less than 70%, and/or less than 20%, and/or less than 15%, of said feed flow passes through said membrane.

10. A method according to claim 1, wherein the method comprises:
providing at least two monitoring cells;
providing a first aqueous feed flow onto a first receiving surface to be monitored, wherein the first receiving surface is located in a first monitoring cell and comprises a first selective barrier membrane; and
providing a second aqueous feed flow onto a second receiving surface to be monitored, wherein the second receiving surface is located in a second monitoring cell and includes a second selective barrier membrane; and
wherein the first and second aqueous feed flows are similar to each other or different from each other in terms of flow velocity, flow content, flow origin, and/or flow pressure, and the first and second selective barrier membranes are similar to each other or different from each other in terms of membrane material, membrane type, spacer type, and/or spacer thickness.

11. A method according to claim 1, the method comprising:
classifying a quality and type of deposition attached to said receiving surface based on information obtained from said analyzed visual data; and
computing a quantitative scaling and/or fouling indication of said receiving surface based on said classification.

12. A method according to claim 1, the method comprising:
based on information obtained from said analyzed visual data, computing an overall scaling and/or fouling indication of said receiving surface.

13. A method according to claim 1, the method comprising:
adding to said feed flow of an aqueous liquid at least one fluorescent dye capable of staining at least one type of microbes;
illuminating at least part of said receiving surface with at least two light sources, at least one of which uses light with a selected wavelength that excites a biofouling deposition stained by said at least one fluorescent dye; and
classifying a quality and type of biofouling deposition on said receiving surface based on fluorescence emission from said depositions in said analyzed visual data.

14. A method according to claim 1, wherein said light source is emitting ultraviolet light.

15. A method according to claim 13, the method comprising:
illuminating at least part of said receiving surface with at least two light sources, at least one of which uses light with a selected wavelength that excites inorganic or organic deposition stained by said at least one fluorescent dye.

16. A method of claim 1, wherein the quantitative scaling and/or fouling indication of said receiving surface is based on one or more of the following: total fouling of said surface, fouling rate, color map of fouling, and/or share or ratio of each fouling type.

17. A method of claim 13, wherein the classification of the quality and type of said depositions on said receiving surface is done in a computer unit by using one or more of the following: shape factors, aspect ratio, size factors, size distribution or mean size, color factors, mean color, and/or color distribution and brightness, of the depositions imaged.

18. A method of claim 1, wherein said selective barrier membrane includes a reverse osmosis, nanofiltration, ultrafiltration or a microfiltration semipermeable membrane.

19. A method of claim 1, the method comprising:
connecting at least two monitoring cells to be monitored in parallel or in series with regard to the feed and reject flows; and
collecting visual data of the surfaces of said at least two monitoring cells.

20. A method of claim 1, wherein said feed flow is at least one of the following: saline water, brackish water, circulated water, wastewater, and/or industrial process water.

21. A method of claim 1, wherein:
said feed flow is a side stream taken from a main process stream; and
said quantitative indication of said deposition on said receiving surface, compared to a clean surface used as a reference, is used as an input parameter for automatic control of an addition of one or more chemicals to said main process stream.

22. A method according to claim 21, wherein said chemical is selected from the group consisting of antiscalants, biocides, coagulants, flocculants, oxidants, disinfectants, cleaning chemicals, polymers and/or any combination thereof.

23. An apparatus for monitoring deposit formation in a process having an aqueous flow, the apparatus comprising
feeding means for providing a feed flow of aqueous liquid onto a receiving surface to be monitored, wherein the receiving surface is located in a monitoring cell;
a light source configured to illuminate at least part of said receiving surface with a light source;
an imaging device configured to collect visual data at a multitude of positions across said receiving surface;
a data processing unit configured to analyze said visual data; and
computing means configured to compute a quantitative scaling and/or fouling indication for said receiving surface based on said analysing;
wherein the monitoring cell has an inlet for the aqueous feed flow and an outlet for a reject flow from the monitoring cell, and the receiving surface includes a selective barrier membrane; and
wherein said feeding means are configured to direct the feed flow to the receiving surface at an elevated pressure to produce from said feed flow a permeate part that is passing through said selective barrier membrane and a concentrate part that forms said reject flow.

24. An apparatus according to claim 23 for monitoring deposit formation in a process having an aqueous flow, the apparatus comprising:
feeding means for providing a feed flow of aqueous liquid onto the receiving surface to be monitored, wherein the receiving surface is located in the monitoring cell, wherein said monitoring cell includes at least one layer of a spacer applied on the receiving surface;
a light source configured to illuminate at least part of said receiving surface and/or spacer with the light source;
an imaging device configured to collect visual data at a multitude of positions across said receiving surface and/or said spacer;
a data processing unit configured to analyze said visual data; and
computing means configured to compute a quantitative scaling and/or fouling indication for said receiving surface and/or spacer based on said analysing.

25. An apparatus according to claim 24, wherein said elevated pressure is an overpressure of 0.1 to 60 bar, and/or the selective barrier membrane is a semipermeable membrane.

26. An apparatus according to claim 24, wherein said elevated pressure is an overpressure of 0.1 to 1 bar, and/or 0.1 to 0.5 bar, and the membrane is a microfiltration membrane.

27. An apparatus according to claim 24, wherein said elevated pressure is an overpressure of 1 to 5 bar, and/or 1 to 3 bar, and the membrane is an ultrafiltration membrane.

28. An apparatus according to claim 24, wherein said elevated pressure is an overpressure of 4 to 15 bar, and/or 5 to 10 bar, and the membrane is a nanofiltration membrane.

29. An apparatus according to claim 24, wherein said elevated pressure is an overpressure of 10 to 60 bar, and/or 10 to 40 bar, and the membrane is a reverse osmosis membrane.

30. An apparatus according to claim 24, wherein said feeding means are configured to direct said feed flow to the receiving surface at said elevated pressure, such that:
1 to 99%, and/or at least 2%, and/or at least 25%, and/or at least 30%, and/or at least 80%, and/or at least 85%, of said feed flow passes through said membrane; and
1 to 99%, and/or less than 98%, and/or less than 75%, and/or less than 70%, and/or less than 20%, and/or less than 15%, of said feed flow forms said reject flow.

31. An apparatus according to claim 23, wherein said feeding means are configured to direct said feed flow to the receiving surface at said elevated pressure, such that:
1 to 99%, and/or at least 2%, and/or at least 25%, and/or at least 30%, and/or at least 80%, and/or at least 85%, of said feed flow forms said reject flow, and
1 to 99%, and/or less than 98%, and/or less than 75%, and/or less than 70%, and/or less than 20%, and/or less than 15%, of said feed flow passes through said membrane.

32. An apparatus according to claim 23, wherein the apparatus comprises:
at least two monitoring cells, wherein
a first monitoring cell includes first feeding means for providing a first aqueous feed flow onto a first receiving surface to be monitored, wherein the first receiving surface is located in the first monitoring cell and includes a first selective barrier membrane; and
a second monitoring cell includes second feeding means for providing a second aqueous feed flow onto a second receiving surface to be monitored, wherein the second receiving surface is located in the second monitoring cell and includes a second selective barrier membrane;
such that the first and second aqueous feed flows are similar to each other or different from each other in terms of flow velocity, flow content, flow origin, and/or flow pressure; and
wherein the first and second selective barrier membranes are similar to each other or different from each other in terms of membrane material, membrane type, spacer type and/or spacer thickness.

33. An apparatus of claim 23, comprising:
a classifying algorithm for classifying the quality and/or type of deposition attached to said receiving surface based on information obtained from said analyzed visual data;
wherein the data processing unit is configured to compute a quantitative scaling and/or fouling indication of said receiving surface based on said classification.

34. An apparatus of claim 23, wherein the data processing unit is configured to:
based on information obtained from said analyzed visual data, compute an overall scaling and/or fouling indication of said receiving surface.

35. An apparatus of claim 24, wherein said membrane includes a reverse osmosis, nanofiltration, ultrafiltration or a microfiltration semipermeable membrane.

36. An apparatus of claim 24, comprising:
at least two monitoring cells to be monitored connected in parallel with regard to the feed and reject flows; and
wherein said imaging device is configured to collect visual data of the surfaces of said at least two monitoring cells.

37. An apparatus of claim 33, comprising:
means for taking said feed flow as a side stream taken from a main process stream; and
control means configured to use said quantitative indication of said deposition on said receiving surface, compared to a clean surface as a reference, as an input parameter for automatic control of an addition of one or more chemicals to said main process stream.

38. An apparatus according to claim 37, wherein said chemical is selected from the group consisting of antiscalants, biocides, coagulants, flocculants, oxidants, disinfectants, cleaning chemicals, polymers and/or any combination thereof.

39. A method according to claim 1, comprising:
performing a water treatment process, a waste water treatment process, and/or a drinking water treatment process; and/or
performing an industrial process, an industrial process of food and beverage industry, pulp and paper manufacturing, and/or oil and gas industry; and/or
performing a mining process; and
predicting or estimating fouling and/or deposition of impurities on a selective barrier membrane receiving surface in said process.
